(19) United States
(12) Patent Application Publication
(10) Pub. No.: US 2008/0202481 A1
(43) Pub. Date: Aug. 28, 2008

(54) Vapor recovery system for a vehicle fuel tank

(76) Inventor: Andrzej Kalina, Wieliczka (PL)

Correspondence Address: DELPHI TECHNOLOGIES, INC., M/C 480-410-202, PO BOX 5052, TROY, MI, 48007, US

(21) Appl. No.: 12/069,338

(22) Filed: Feb. 8, 2008

(30) Foreign Application Priority Data
Feb. 8, 2007 (EP) 07250509.2

(51) Int. Cl. F02M 33/02

(52) U.S. Cl. 123/520

(57) ABSTRACT

A vapor recovery system for a vehicle fuel tank comprising a canister having a first chamber containing a first body of adsorbent material for adsorbing fuel from fuel vapor laden air, said first chamber having a vent inlet for communication with the headspace of a vehicle fuel tank, a vent outlet for communication with the atmosphere and a purge outlet for communication with the air intake of the vehicle engine via a purge flow path, an adsorption flow path being defined through said first body of adsorbent material between said vent inlet and vent outlet, a flow delaying means being provided within the purge flow path downstream of said purge outlet and upstream of said air intake for delaying the passage of gases through said purge flow path, a hydrocarbon sensing means being provided for sensing the presence of hydrocarbons in said purge flow path downstream of flow delaying means, the vapor recovery system further comprising control means, the control means determining a time interval between an initiation of a canister purge cycle for purging the first body of adsorbent material of hydrocarbons and the detection of hydrocarbons by the hydrocarbon sensing means, the control means determining the amount of hydrocarbon adsorbed by the canister in a previous adsorption cycle based upon such time interval.

### TECHNICAL FIELD

The present invention relates to a vapor recovery system for a vehicle fuel tank comprising a canister containing an adsorbent material, such as carbon, for adsorbing fuel from fuel vapor laden air, and to a method for determining the amount of hydrocarbons adsorbed by the canister.

### BACKGROUND OF THE INVENTION

It is necessary to vent the air space in the upper regions of a vehicle fuel tank (known as the headspace) in order to avoid the formation of an air lock as a tank is emptied in use, during refuelling when air is displaced from the headspace as the tank is filled with fuel, and to compensate for pressure changes in the headspace due to evaporation of fuel and subsequent condensation during changes in ambient temperature.

However, vehicle emission standards place limits on the evaporative emission of fuel vapor from vehicle fuel tanks and fuel systems. To achieve these emission standards, most modern vehicles are equipped with venting and vapor recovery systems for preventing the release of fuel vapor during refilling, during vehicle operation and while the vehicle is stationary, while at the same time allowing the volume of air and fuel vapor in the tank to vary as the volume of fuel in the tank varies.

As illustrated in FIGS. 1 and 2, a typical vapor recovery system comprises an adsorption canister 1 containing an activated carbon filter material 2 having an inlet 3 connected to a tank headspace vent passage, to trap fuel vapor while permitting the passage of air through a vent port 4 to the atmosphere during refuelling of a vehicle. Periodically, during operation of the vehicle, adsorbed fuel vapor trapped in the canister is removed by drawing air through the canister 1 through a purge outlet 5 communicating with the air-intake system of the engine such that the desorbed fuel vapor is burnt in the engine. Such operation is referred to hereinafter as a “purge cycle”. The hydrocarbons are desorbed, transferred to engine and burnt. In order to avoid the passage of air directly from the vent outlet to the purge outlet during the purge cycle, a partition wall 7 extends within the canister 1 between the vent outlet and purge outlet.

The main function of the canister is to adsorb vapors from the fuel system and reduce environmental pollution due to evaporative emissions from gasoline powered engines.

Typically, the vapor recovery system includes a purge valve 6 between the canister purge outlet 5 and the engine. On most of the systems the purge valve 6 (normally solenoid valve) is controlled by an ECU. The ECU periodically opens the valve to allow hydrocarbons flow to engine. The periodical operation is required to limit amount of hydrocarbons delivered to engine. This is critical for engine performance, drivability and vehicle exhaust emissions.

The emission performance of evaporative control system is mainly related to canister purge conditions. This purge strategy should:

maximise amount of fresh air for purge cycle; the larger the air volume used the less bleed emissions of canister and fuel system;

purge the canister at conditions which have no negative impact on tailpipe emissions and engine performance.

Today engine and evaporative control systems operate on the principle of feedback closed loop control provided by a lambda sensor and duty cycle control of the purge valve. The lambda sensor signal is used by the ECU to verify if the fuel-air mixture is stoichiometric and optimum firing conditions are provided. If too much or too little hydrocarbons are delivered to the engine from the canister purge, the air/fuel mixture supplied to the engine becomes either too rich or to lean. Such condition is identified by lambda sensor and the ECU alters the purge valve to obtain stoichiometric conditions.

The disadvantage of the feedback control principle is delay in response, which may cause either emission problems or engine performance issues, including engine stalling.

To eliminate this disadvantage a feed-forward solution with HC sensing technique is proposed in U.S. Pat. No. 6,293,261. A hydrocarbon sensor is used to predict purge hydrocarbons content rather than ECU and feedback lambda sensor signal. This solution eliminates most of feedback closed-loop drawbacks; however, the purging of the canister still can not be optimised because such solution cannot determine the condition of the canister (i.e. the amount of hydrocarbons adsorbed by the canister compared to the total working capacity of the canister).

### SUMMARY OF THE INVENTION

According to the present invention there is provided a vapor recovery system for a vehicle fuel tank comprising a canister having a first chamber containing a first body of adsorbent material for adsorbing fuel from fuel vapor laden air, said first chamber having a vent inlet for communication with the headspace of a vehicle fuel tank, a vent outlet for communication with the atmosphere and a purge outlet for communication with the air intake of the vehicle engine via a purge flow path, an adsorption flow path being defined through said first body of adsorbent material between said vent inlet and vent outlet, a second body of adsorbent material defining a buffer being provided within the purge flow path downstream of said purge outlet and upstream of said air intake for delaying the passage of fuel vapor through said purge flow path, a hydrocarbon sensing means being provided for sensing the presence of hydrocarbons in said purge flow path downstream of the buffer, the vapor recovery system further comprising control means, the control means determining a time interval between an initiation of a canister purge cycle for purging the first body of adsorbent material of hydrocarbons and the detection of hydrocarbons by the hydrocarbon sensing means, the control means determining the amount of hydrocarbon adsorbed by the canister in a previous adsorption cycle based upon such time interval.

Preferably said purge outlet of the first chamber is provided adjacent said vent inlet.

Said second body of adsorbent material may be provided within a second chamber defined within the canister, said second chamber having an inlet end communicating with the purge outlet of said first chamber and an outlet end communicating with the air intake of the engine. An internal wall or partition may be provided within the canister separating said first and second chambers. Alternatively said second body of adsorbent material may be provided within a purge line between the purge outlet of the first chamber and the air intake of the engine or within a further canister or hollow body provided in said purge line and having an inlet connected to said purge outlet of said first chamber and an outlet for communication with said air intake of the engine.

During a purge cycle, the flow restriction caused by the second body of adsorbent material contained in the purge flow path delays the passage of fuel vapor and air therethrough, thereby delaying the detection of hydrocarbons by the hydrocarbon sensing means. Such delay is a function of canister conditions. The more the canister is loaded with hydrocarbons the shorter the delay. This information can used by control means to determine they canister loading and thus establish optimum purge strategy for canister. In addition the delay line provides a buffer effect which eliminates cross-talk between tank and engine manifold (i.e. the drawing for fuel vapor directly from the tank headspace to the engine intake during a canister purge cycle). Such cross-talk is an unwanted phenomenon and it may have serious implications, including drivability and engine calibration problems.

According to a second aspect of the present invention there is provided a method of determining the amount of fuel vapor adsorbed by an adsorption canister of a vapor recovery system, the method comprising providing a buffer comprising a body of adsorbent material downstream of a purge outlet of a canister between the canister and the air intake of an engine, providing fuel vapor detecting means downstream of the buffer, initiating a purge cycle of the canister during which fuel vapor and air is drawn through an adsorbent material contained in the canister between a vent outlet and the purge outlet, determining the time interval between initiation of the purge cycle and detection of fuel vapor by the fuel vapor detecting means and determining the amount of fuel vapor adsorbed by the vapor recovery canister based upon said time interval.

### BRIEF DESCRIPTION OF THE DRAWINGS

Embodiments of the present invention will now be described, by way of example only, with reference to the accompanying drawings, in which:

FIG. 1 is a schematic view of a known vapor recovery system during a canister load cycle, such as when the vehicle in inoperative.

FIG. 2 is a schematic view of the vapor recovery system of FIG. 1 during a canister purge cycle; and

FIG. 3 is a schematic view of a vapor recovery system according to the present invention.

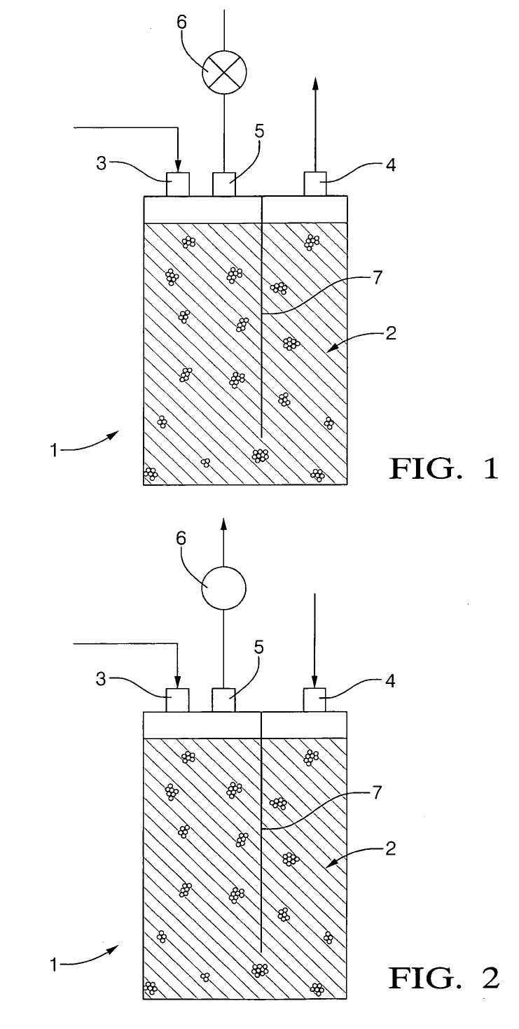

### DESCRIPTION OF THE PREFERRED EMBODIMENTS

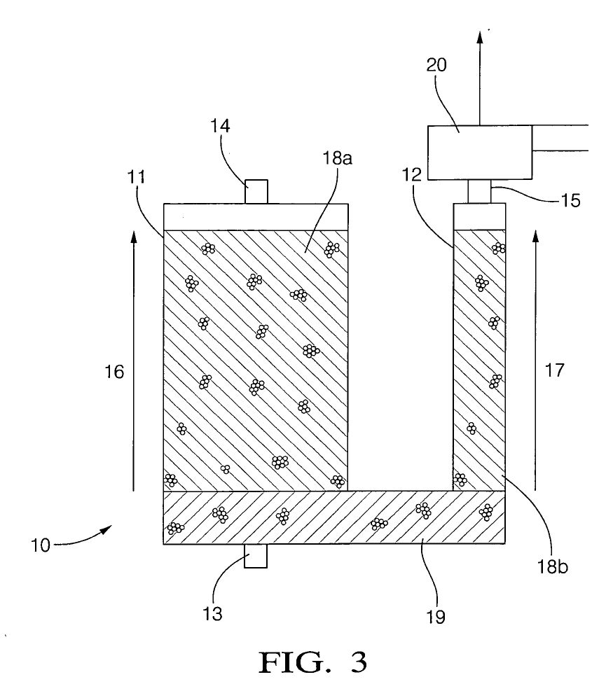

As illustrated in FIG. 3, a vapor recovery system for a vehicle fuel tank according to a first embodiment of the present invention comprises a canister 10 divided into first and second chambers 11,12, each chamber containing a body of adsorbent material 18a, 18b, such as activated carbon, for adsorbing fuel from fuel vapor laden air. The region 19 below and linking the first and second chambers 11,12 may also optionally contain fuel vapor adsorbent material. The canister 10 has an inlet 13 for connection to the headspace of a vehicle fuel tank, a vent outlet 14 communicating with the atmosphere and a purge outlet 15 for communication with the air intake of the vehicle engine. The first chamber 11 defines an adsorption flow path 16 between the inlet and the vent outlet and the second chamber 12 defines a purge flow path 17 between the inlet and the purge outlet.

In the embodiment shown in FIG. 3, the first chamber 11 is wider than the second chamber whereby the purge flow path has a greater flow restriction than the adsorption flow path.

A hydrocarbon sensor 20 is provided downstream of the purge outlet 15. A purge valve (not shown) is provided in a purge line between the purge outlet and the air intake of the engine to control communication between the engine and the purge outlet.

The system includes an electronic control unit (ECU) to control the operation of the purge valve, the ECU receiving a signal from the hydrocarbon sensor.

The purge flow path 17 through the adsorbent material in the second chamber 12 defines a buffer, delaying the passage of fuel vapor from the adsorbent material in the first chamber 11 to the purge outlet 12 during a canister purge cycle. The delay is a function of canister conditions: The more the canister is loaded with hydrocarbons (i.e. fuel vapor) the shorter the delay. This information is used by ECU to establish optimum purge strategy for canister. In addition, the second chamber 12 and its adsorbent material 18b provides a buffer effect which eliminates cross-talk between tank and engine manifold. Such cross-talk is an unwanted phenomenon and may have serious implications, including drivability and engine calibration problems.

When the purge valve is closed, fuel vapor and air from the headspace of the fuel tank can pass through the canister inlet 13 into the first chamber 11. Fuel vapor is adsorbed by the adsorbent material 18a in the first chamber 11 and air can pass out of the vent outlet 14 to maintain ambient pressure within the tank headspace. During such adsorption cycle, there is limited flow through the second chamber 12, mainly by diffusion, and therefore the adsorbent material 18b in the purge flow path 17 adsorbs little fuel vapor from the tank. Thus the adsorbent material 18b in the second chamber 12 remains substantially hydrocarbon free during the adsorption cycle.

When the purge valve is opened to initiate a canister purge cycle, vapors from first chamber 11 of the canister flow through the adsorbent material 18b in the purge flow path 17. Under such conditions, the purge flow path 17 acts as delay line, as discussed above and the ECU can determine the canister loading, and thus the optimum purge strategy, based upon the measured delay. The determination of the canister loading is based upon the known volume of the canister and the known flow rate of gases through the purge flow line during a purge cycle, which, in combination with the time interval between initiation of the purge cycle and detection of fuel vapor (hydrocarbons) by the hydrocarbon sensor.

Various modifications and variations to the described embodiments of the inventions will be apparent to those skilled in the art without departing from the scope of the invention as defined in the appended claims. Although the invention has been described in connection with specific preferred embodiments, it should be understood that the invention as claimed should not be unduly limited to such specific embodiments.

1. A vapor recovery system for a vehicle fuel tank comprising:
a canister having a first chamber containing a first body of adsorbent material for adsorbing fuel from fuel vapor laden air, said first chamber having a vent inlet for communication with the headspace of a vehicle fuel tank,
a vent outlet for communication with the atmosphere, and
a purge outlet for communication with the air intake of the vehicle engine via a purge flow path,
said vapor recovery system further comprising:
an adsorption flow path being defined through said first body of adsorbent material between said vent inlet and vent outlet, wherein a second body of adsorbent material defining a buffer is provided within the purge flow path downstream of said purge outlet and upstream of said engine air intake for delaying the passage of fuel vapor through said purge flow path,
a hydrocarbon sensing means for sensing the presence of hydrocarbons in said purge flow path downstream of the buffer,
said vapor recovery system still further comprising control means, the control means determining a time interval between an initiation of a canister purge cycle for purging the first body of adsorbent material of hydrocarbons and the detection of hydrocarbons by the hydrocarbon sensing means, the control means determining the amount of hydrocarbon adsorbed by the canister in a previous adsorption cycle based upon such time interval.

2. The vapor recovery system as claimed in claim 1, wherein said purge outlet of the first chamber is provided adjacent said vent inlet.

3. The vapor recovery system as claimed in claim 1, wherein said second body of adsorbent material is provided within a second chamber defined within the canister, said second chamber having an inlet end communicating with the purge outlet of said first chamber and an outlet end communicating with the air intake of the engine.

4. The vapor recovery system as claimed in claim 3, wherein an internal wall or partition is provided within the canister separating said first and second chambers.

5. The vapor recovery system as claimed in claim 1, wherein said second body of adsorbent material is provided within a purge line between the purge outlet of the first chamber and the air intake of the engine or within a further canister or hollow body provided in said purge line and having an inlet connected to said purge outlet of said first chamber and an outlet for communication with said air intake of the engine.

6. A method of determining the amount of fuel vapor adsorbed by an adsorption canister of a vapor recovery system, the method comprising the steps of:
providing a buffer comprising a body of adsorbent material downstream of a purge outlet of a canister between the canister and the air intake of an engine,
providing fuel vapor detecting means downstream of the buffer,
initiating a purge cycle of the canister during which fuel vapor and air is drawn through an adsorbent material contained in the canister between a vent outlet and the purge outlet,
determining the time interval between initiation of the purge cycle and detection of fuel vapor by the fuel vapor detecting means, and
determining the amount of fuel vapor adsorbed by the vapor recovery canister based upon said time interval.
